(19) United States
(12) Patent Application Publication
(10) Pub. No.: US 2019/0319287 A1
(43) Pub. Date: Oct. 17, 2019

(54) ANTIOXIDANT FOR POLYMER ELECTROLYTE MEMBRANE FUEL CELLS, ELECTROLYTE INCLUDING THE SAME, AND MEMBRANE-ELECTRODE ASSEMBLY FOR VEHICLES INCLUDING THE SAME

(71) Applicants: Hyundai Motor Company, Seoul (KR); Kia Motors Corporation, Seoul (KR)

(72) Inventors: In Yu Park, Seoul (KR); Bo Ki Hong, Seoul (KR); Jae Jun Ko, Gunpo (KR); Jung Han Yu, Yongin (KR)

(21) Appl. No.: 16/186,155

(22) Filed: Nov. 9, 2018

(30) Foreign Application Priority Data
Apr. 11, 2018 (KR) 10-2018-0042297

(51) Int. Cl. H01M 8/1051; H01M 8/1004; C09K 15/02

(52) U.S. Cl. CPC H01M 8/1051; H01M 2008/1095; C09K 15/02; H01M 8/1004

(57) ABSTRACT

Disclosed are an antioxidant for polymer electrolyte membrane fuel cells including barium cerium oxide and one or more rare-earth elements and having a Perovskite structure, an electrolyte membrane and the membrane-electrode assembly for vehicles including the antioxidant. The antioxidant for polymer electrolyte membrane fuel cells according to the present invention can improve antioxidant activity and long-term stability of electrolyte membranes and enhance durability of fuel cells.

### CROSS-REFERENCE TO RELATED APPLICATION

This application claims, under 35 U.S.C. § 119(a), the benefit of priority to Korean Patent Application No. 10-2018-0042297 filed on Apr. 11, 2018, the entire contents of which are incorporated herein by reference.

### TECHNICAL FIELD

The present invention relates to an antioxidant for polymer electrolyte membrane fuel cells, an electrolyte membrane for fuel cells including the same and a membrane-electrode assembly for vehicles including the same. The antioxidant for polymer electrolyte membrane fuel cells may include barium cerium oxide (BaCeO₃) and one or more rare earth elements, preferably having a Perovskite structure.

### BACKGROUND

Polymer electrolyte membrane fuel cells for vehicles are devices which generate electricity by electrochemical reaction between hydrogen and oxygen in the air and are well-known as environmentally friendly next-generation energy sources that have high electricity-generation efficiency and almost no exhaust materials other than water. In addition, polymer electrolyte membrane fuel cells generally operate at a temperature of 95° C. or less and have high power density. The reaction for electricity production by fuel cells occurs in a membrane-electrode assembly (MEA), which includes a perfluorinated sulfonic acid ionomer-based membrane, and a pair of electrodes including an anode and a cathode. In the membrane-electrode assembly (MEA), hydrogen supplied to an oxidation electrode (i.e. anode) for fuel cells, is split into a proton and an electron, and then the proton is moved through the membrane to a reduction electrode (i.e. a cathode), and the electron is moved via an exterior circuit to the cathode. Then, at the cathode, an oxygen molecule, the proton and the electron react together, thus producing electricity and heat, and at the same time, water (H₂O), as a by-product.

In general, hydrogen and oxygen in the air, which are reaction gases for fuel cells, crossover through the electrolyte membrane to facilitate production of hydrogen peroxide (HOOH). The hydrogen peroxide produces oxygen-containing radicals such as a hydroxyl radical (.OH) and a hydroperoxyl radical (.OOH). These radicals attack the perfluorinated sulfonic acid-based electrolyte membrane, inducing chemical degradation of the membrane, which finally has a negative impact of reducing durability of fuel cells.

In related arts, electrolyte membranes containing an antioxidant have been manufactured in order to solve these conventional problems and improve durability of electrolyte membranes. For example, as the amount of antioxidant added increases, durability of electrolyte membranes increases, but ionic conductivity decreases, thus causing deterioration in overall performance. Accordingly, it is necessary to secure both improved durability and performance of electrolyte membranes.

The above information disclosed in this Background section is provided only for enhancement of understanding of the background of the invention and therefore it may contain information that does not form the prior art that is already known in this country to a person of ordinary skill in the art.

### SUMMARY OF THE INVENTION

In preferred aspects, The present invention provides an antioxidant for polymer electrolyte membrane fuel cells to secure antioxidant activity, durability and ionic conductivity of electrolyte membranes.

Further provided is an electrolyte membrane for fuel cells to secure both chemical durability and performance of fuel cells. Moreover, the present invention provides a membrane-electrode assembly for vehicles to secure improved chemical durability, lifespan and power of fuel cells.

In one aspect, provided is an antioxidant for polymer electrolyte membrane fuel cells including barium cerium oxide and one or more rare-earth elements. In particular, the barium cerium oxide may suitably be complexed with the one or more rare-earth elements. In particular, the barium cerium oxide may suitably be doped with the one or more rare-earth elements. For example, the barium cerium oxide doped with the one or more rare-earth elements may have a Perovskite structure.

The rare-earth element may suitably include at least one of yttrium (Y) or samarium (Sm).

The barium cerium oxide doped with the rare-earth element may be represented by the following Formula 1 or Formula 2:

BaCe₁₋ₓYₓO_{3-δ}(BCY) [Formula 1]

BaCe₁₋ₓSmₓO_{3-δ}(BCS), [Formula 2]

wherein X is a number greater than 0 and not greater than 0.5; and δ is a number greater than 0 and not greater than 0.25.

In another aspect, the present invention provides an electrolyte membrane for polymer electrolyte membrane fuel cells. The electrolyte membrane may suitably include an ionomer, and an antioxidant having a Perovskite structure. In particular, the antioxidant may include barium cerium oxide doped with a rare-earth element.

The ionomer may suitably be a perfluorinated sulfonic acid ionomer, a hydrocarbon ionomer and a mixture thereof.

The rare-earth element may suitably include at least one of yttrium (Y) or samarium (Sm).

The barium cerium oxide doped with the rare-earth element may be represented by the following Formula 1 or Formula 2:

BaCe₁₋ₓYₓO_{3-δ}(BCY) [Formula 1]

BaCe₁₋ₓSmₓO_{3-δ}(BCS), [Formula 2]

wherein X is a number greater than 0 and not greater than 0.5; and

δ is a number greater than 0 and not greater than 0.25.

The antioxidant may be present in an amount of about 0.05 to 20% by weight, based on the total weight of the electrolyte membrane.

In another aspect, the present invention provides a membrane-electrode assembly for vehicles including a cathode, an electrolyte membrane disposed on the cathode and contacting the cathode, and an anode disposed on the electrolyte membrane and contacting the electrolyte membrane. The electrolyte membrane may include an ionomer, and an antioxidant having a Perovskite structure. Particularly, the antioxidant may suitably include barium cerium oxide doped with a rare-earth element.

The ionomer may suitably be a perfluorinated sulfonic acid ionomer, a hydrocarbon ionomer and a mixture thereof.

The rare-earth element may suitably include at least one of yttrium (Y) or samarium (Sm).

The barium cerium oxide doped with the rare-earth element may be represented by the following Formula 1 or Formula 2:

BaCe₁₋ₓYₓO_{3-δ}(BCY) [Formula 1]

BaCe₁₋ₓSmₓO_{3-δ}(BCS), [Formula 2]

wherein X is a number greater than 0 and not greater than 0.5; and

δ is a number greater than 0 and not greater than 0.25.

The antioxidant may be present in an amount of about 0.05 to 20% by weight, based on the total weight of the electrolyte membrane.

Further provided is a vehicle that may include the membrane-electrode assembly as described herein.

Other aspects of the invention are disclosed infra.

### BRIEF DESCRIPTION OF THE DRAWINGS

The above and other features of the present invention will now be described in detail with reference to certain exemplary embodiments thereof illustrated in the accompanying drawings which are given herein below by way of illustration only, and thus are not limitative of the present invention, and wherein:

FIG. 1 shows an exemplary membrane-electrode assembly for vehicles according to an exemplary embodiment of the present invention;

FIG. 2 shows an exemplary color change based on a methyl violet method to evaluate antioxidant activities of Example 1 and Example 2 according to exemplary embodiments of the present invention and Comparative Example 1 respectively;

FIG. 3 is an exemplary graph showing absorbance intensity of Example 1 and Example 2 according to exemplary embodiments of the present invention and Comparative Example 1 respectively; and

FIG. 4 is an exemplary graph showing fluorine emission rate of Example 1 and Example 2 according to exemplary embodiments of the present invention and Comparative Example 1 respectively.

### DETAILED DESCRIPTION

The objects described above, and other objects, features and advantages will be clearly understood from the following preferred embodiments with reference to the annexed drawings.

However, the present invention is not limited to the embodiments and will be embodied in different forms. The embodiments are suggested only to offer thorough and complete understanding of the disclosed contents and to sufficiently inform those skilled in the art of the technical concept of the present invention.

Like reference numbers refer to like elements throughout the description of the figures. In the drawings, the sizes of structures are exaggerated for clarity. It will be understood that, although the terms first, second, etc. may be used herein to describe various elements, these elements should not be limited by these terms and are used only to distinguish one element from another. For example, within the scope defined by the present invention, a first element may be referred to as a second element and similarly, a second element may be referred to as a first element. Singular forms are intended to include plural forms as well unless context clearly indicates otherwise.

As used herein, the singular forms “a,” “an” and “the” are intended to include the plural forms as well, unless the context clearly indicates otherwise. It will be further understood that the terms “comprises”, “has” and the like, when used in this specification, specify the presence of stated features, numbers, steps, operations, elements, components or combinations thereof, but do not preclude the presence or addition of one or more other features, numbers, steps, operations, elements, components, or combinations thereof. In addition, it will be understood that when an element such as a layer, film, region or substrate is referred to as being “on” another element, it can be directly on the other element or an intervening element may also be present. It will also be understood that, when an element such as a layer, film, region or substrate is referred to as being “under” another element, it can be directly under the other element or an intervening element may also be present.

Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, the antioxidant for polymer electrolyte membrane fuel cells, the electrolyte membrane for fuel cells including the same and the membrane-electrode assembly for vehicles including the same according to an embodiment of the present invention will be described.

The fuel cell may be, for example, a membrane-electrode assembly. The fuel cell may be an energy source of vehicles. The vehicle may be a means used to transport an object, a person or the like. The vehicle may be, for example, a land vehicle, a marine vessel or an aircraft. Examples of the land vehicle may include cars including passenger cars, vans, trucks, trailer trucks and sports cars, bicycles, motorcycles, trains and the like. Examples of the marine vessel may include ships and submarines. Examples of the aircraft may include airplanes, hang gliders, hot air balloons, helicopters and small aircraft such as drones.

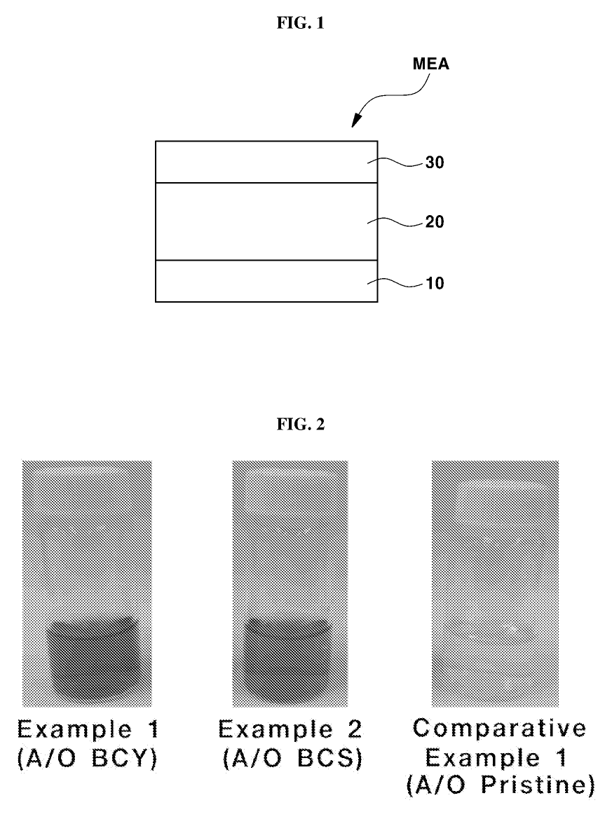

FIG. 1 shows an exemplary membrane-electrode assembly for vehicles according to an exemplary embodiment of the present invention.

As shown in FIG. 1, the membrane-electrode assembly (MEA) for vehicles according to an exemplary embodiment of the present invention includes a cathode 10, an electrolyte membrane 20 and an anode 30.

Hydrogen supplied from the anode 30 is split into protons and electrons. The protons are moved through the electrolyte membrane 20 to the cathode 10. Electrons are moved via an exterior circuit to the cathode 10. At the cathode 10, an oxygen molecule, protons and electrons react to produce electrical energy and thermal energy.

The electrolyte membrane 20 is provided on the cathode 10 and the electrolyte membrane 20 contacts the cathode 10. The electrolyte membrane 20 is provided between the cathode 10 and the anode 30. The electrolyte membrane 20 contacts the cathode 10 and the anode 30 respectively. The anode 30 is provided on the electrolyte membrane 20. The anode 30 contacts the electrolyte membrane 20.

The electrolyte membrane 20 may include an ionomer and an antioxidant. The ionomer may suitably be a perfluorinated sulfonic acid-based ionomer or a hydrocarbon-based ionomer. For example, the perfluorinated sulfonic acid-based ionomer may suitably include Nafion, and the hydrocarbon-based ionomer may be polyether ketone, polyether sulfone-based polyarylene ether or the like.

The term “-based” may include a compound corresponding to “-” or a derivative of “-”. The term “derivative” means a compound which is modified from a certain compound as a precursor while retaining the structure and characteristics of the precursor such as introduction of a functional group, oxidation, reduction, or substitution of an atom.

The antioxidant for polymer electrolyte membrane fuel cells according to an exemplary embodiment of the present invention may function as a radical scavenger or quencher. The antioxidant may include barium cerium oxide and one or more rare-earth elements. The barium cerium oxide and the one or more rare-earth elements may suitably be complexed. In particular, the barium cerium oxide may be doped with the one or more rare-earth elements, which may suitably have a Perovskite structure.

In the barium cerium oxide doped with a rare-earth element, the rare-earth element may increase oxygen vacancies by substituting a part of cerium (IV) ions (Ce⁴±) by a yttrium ion (Y³±) or a samarium ion (Sm³±). The oxygen vacancy produced by doping with the rare-earth element may improve redox reaction properties of cerium ions.

The rare-earth element, for example, may suitably include at least one of yttrium (Y) or samarium (Sm).

The barium cerium oxide doped with the rare-earth element is, for example, represented by the following Formula 1 or Formula 2.

BaCe₁₋ₓYₓO_{3-δ}(BCY) [Formula 1]

BaCe₁₋ₓSmₓO_{3-δ}(BCS), [Formula 2]

In Formulae 1 and 2, X is a number greater than 0 and not greater than 0.5, δ is a number greater than 0 and less than 3, specifically, is a number greater than 0 and not greater than 1, or particularly, a number greater than 0 and not greater than 0.25.

The molar ratio of yttrium to cerium or the molar ratio of samarium to cerium, such as a molar ratio of Yₓ to Ce₁₋ₓ or Smₓ to Ce₁₋ₓ may be 0<x≤0.5. When the molar ratio of Y or Sm is greater than 0.5(for example, 50 mol %), inherent structural properties of barium cerium oxide may be deteriorated.

The antioxidant may be present in an amount of about 0.05 to 20% by weight, based on the weight of the electrolyte membrane 20. When the antioxidant is present in an amount of less than about 0.05% by weight, antioxidant activity may not be sufficient to improve the chemical durability of the electrolyte membrane 20, and when the antioxidant is present in an amount of greater than 20% by weight, the proton conductivity of the electrolyte membrane may be deteriorated and brittleness may be increased.

A conventional antioxidant, which is included in the electrolyte membrane in the related arts, has a problem of deteriorating ionic conductivity, and thus decreasing lifespan and power of the fuel cell, for example, the membrane-electrode assembly for vehicles.

The antioxidant for polymer electrolyte membrane fuel cells and an electrolyte membrane for fuel cells according to an exemplary embodiment of the present invention may include barium cerium oxide doped with a rare-earth element. Accordingly, the antioxidant functions to both conduct protons and scavenge radicals, as well as improve redox reaction properties of cerium ions by rare-earth element doping. Therefore, the durability of the electrolyte membrane may be secured, while retaining the ionic conductivity of the electrolyte membrane including the antioxidant.

Accordingly, a fuel cell including the electrolyte membrane for fuel cells according to an exemplary embodiment of the present invention and a membrane-electrode assembly for vehicles according to an exemplary embodiment of the present invention may include the antioxidant for polymer electrolyte membrane fuel cells according to an exemplary embodiment of the present invention, thereby improving lifespan and power, as compared to conventional fuel cells and membrane-electrode assemblies.

### EXAMPLE

Hereinafter, the present invention will be described in more detail with reference to specific examples. However, the examples are provided only for illustration of the present invention and should not be construed as limiting the range of the present invention.

### Example 1

0.3% by weight of BaCe_{0.85}Y_{0.15}O_{2.925} as an antioxidant was mixed with a perfluorinated sulfonic acid ionomer dispersion (Nafion D2021, DuPont Co., USA) and the mixture was subjected to bar coating to produce an electrolyte membrane. 0.3% by weight was measured based on the weight of the electrolyte membrane. The electrolyte membrane was cut to a size of width of 5 cm and length of 5 cm.

### Example 2

The same process as in Example 1 was conducted except that BaCe_{0.8}Sm_{0.2}O_{2.9} was used as the antioxidant.

### Comparative Example 1

Casting only using a perfluorinated sulfonic acid ionomer dispersion without an antioxidant and then drying were conducted to produce an electrolyte membrane.

Measurement and Evaluation of Physical Properties

1. Evaluation of Antioxidant Activity—Methyl Violet Method

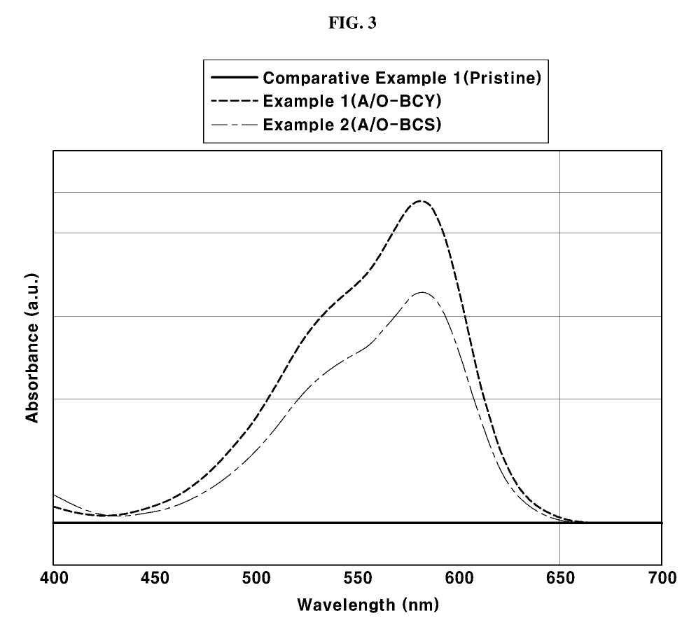

The antioxidant activity of antioxidants of Examples 1 and 2 were respectively evaluated using a methyl violet method. Methyl violet was mixed with iron (II) sulfate heptahydrate (FeSO₄.7H₂O), hydrogen peroxide, and antioxidants of Examples 1 and 2, and change in color was observed. In the present invention, methyl violet, iron (II) sulfate heptahydrate and hydrogen peroxide were mixed in a weight ratio of 30:1:1 to prepare a methyl violet test solution, and about 10 mg of each of the antioxidant samples was added to the test solutions of Examples 1 and 2. An image showing change in color is shown in FIG. 2.

When the antioxidant sufficiently exerts antioxidant activity, methyl violet retains the original color, purple, and when the antioxidant does not exert antioxidant activity, the methyl violet reacts with radicals and becomes colorless.

As shown in FIG. 2, the color of methyl violet of Comparative Example 1 becomes colorless, and Examples 1 and 2 effectively retain purple of methyl violet. Accordingly, the antioxidants used for Examples 1 and 2 sufficiently exert antioxidant activity.

2. Evaluation of Antioxidant Activity—UV-Visible Spectroscopy

The absorbance intensity of methyl violet test solutions of Examples 1 and 2, and Comparative Example 1 using UV-Visible Spectroscopy (UV-3600, Shimadzu Corporation, Japan) was measured. The solution prepared in methyl violet testing was stirred with a stirrer for 24 hours and was subjected to a centrifugal process to remove the antioxidant, and the absorbance intensity of the remaining solution was measured and measurement results are shown in FIG. 3.

When the antioxidant had antioxidant activity, an absorbance peak was observed at a wavelength of 582 nm, which is the inherent absorbance wavelength of methyl violet. When the antioxidant did not have antioxidant activity, the absorbance peak was not observed at the corresponding wavelength.

As shown in FIG. 3, Comparative Example 1 did not show a UV absorbance peak at all, while Examples 1 and 2 showed antioxidant activity of the antioxidant, indicating that the antioxidant still exerts antioxidant activity due to considerably high absorbance intensity.

3. Evaluation of Electrolyte Membrane Durability—Analysis of Fluorine Emission Rate

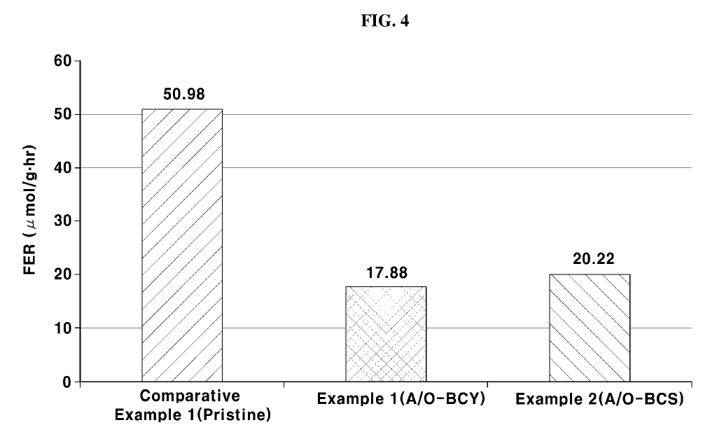

To verify the antioxidant activity in the electrolyte membrane, the electrolyte membranes with antioxidants of Examples 1 and 2 were immersed in a Fenton solution for 3 days and fluorine emission rate (FER) was then measured. More specifically, the Fenton solution was prepared by mixing deionized water, iron (II) sulfate heptahydrate and hydrogen peroxide in a weight ratio of 1:0.000085:0.4, an electrolyte membrane, to which the antioxidants of Examples 1 and 2 were added, and an electrolyte membrane of Comparative Example 1 to which the antioxidants were not added, were immersed in the Fenton solution and reaction was conducted in an oven having a temperature of 80° C. oven for 3 days. Fluorine emission rate was analyzed using the completely reacted Fenton solution and results are shown in FIG. 4.

The electrolyte membrane not including the antioxidant was degraded due to radicals contained in the Fenton solution by reaction between the Fenton solution and the electrolyte membrane to emit a fluorine ion (F⁻). After a predetermined period of time, the concentration of fluorine ions contained in the Fenton solution was measured, thereby checking the durability of the electrolyte membrane.

As shown in FIG. 4, the electrolyte membrane of Comparative Example 1 had a high fluorine emission rate of about 51 μmol/g·hr, the fluorine emission rate of Example 1 was 17.88 μmol/g·hr, and fluorine emission rate of Example 2 was 20.22 μmol/g·hr. Accordingly, Examples 1 and 2 demonstrated that the antioxidants had excellent antioxidant activity.

4. The following Table 1 shows overall antioxidant activity and electrolyte membrane durability of Examples 1 and 2, and Comparative Example 1.

TABLE 1

| | | Durability of electrolyte |
|---|---|---|
| Items | Antioxidant activity | membrane |
| Example 1 | Excellent | Excellent |
| Example 2 | Good | Good |
| Comparative | — | Bad |
| Example 1 | | |

As shown in the above Table 1, in the case of the antioxidants used for Examples 1 and 2, antioxidant activity of antioxidant powders were excellent or good and the durability of the electrolyte membrane can be improved by adding antioxidant powders to the electrolyte membrane.

As apparent from the foregoing, the antioxidant for polymer electrolyte membrane fuel cells according to an exemplary embodiment of the present invention can secure antioxidant activity, chemical durability and ionic conductivity of electrolyte membranes.

The electrolyte membrane for fuel cells according to various exemplary embodiments of the present invention can secure both chemical durability and performance of fuel cells.

The membrane-electrode assembly for vehicles according to an embodiment of the present invention can improve chemical durability, lifespan and power.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. An antioxidant for polymer electrolyte membrane fuel cells comprising barium cerium oxide and one or more rare-earth elements.

2. The antioxidant of claim 1, wherein the barium cerium oxide is complexed with the one or more rare-earth elements.

3. The antioxidant of claim 1, wherein the barium cerium oxide is doped with the one or more rare-earth elements.

4. The antioxidant of claim 1, wherein the barium cerium oxide doped with the rare-earth element has a Perovskite structure.

5. The antioxidant of claim 1, wherein the rare-earth element comprises at least one of yttrium (Y) or samarium (Sm).

6. The antioxidant of claim 3, wherein the barium cerium oxide doped with the one or more rare-earth elements is represented by the following Formula 1 or Formula 2:
BaCe₁₋ₓYₓO_{3-δ}(BCY) [Formula 1]
BaCe₁₋ₓSmₓO_{3-δ}(BCS), [Formula 2]
wherein X is a number greater than 0 and not greater than 0.5; and
δ is a number greater than 0 and not greater than 0.25.

7. An electrolyte membrane for polymer electrolyte membrane fuel cells comprising:
an ionomer; and
an antioxidant having a Perovskite structure,
wherein the antioxidant comprises barium cerium oxide and one or more rare-earth elements.

8. The electrolyte membrane of claim 7, wherein the ionomer is a perfluorinated sulfonic acid ionomer, a hydrocarbon ionomer and a mixture thereof.

9. The electrolyte membrane of claim 7, wherein the one or more rare-earth elements comprise at least one of yttrium (Y) or samarium (Sm).

10. The electrolyte membrane of claim 7, wherein the barium cerium oxide is doped with the one or more rare-earth elements, which is represented by the following Formula 1 or Formula 2:
BaCe₁₋ₓYₓO_{3-δ}(BCY) [Formula 1]
BaCe₁₋ₓSmₓO_{3-δ}(BCS), [Formula 2]
wherein X is a number greater than 0 and not greater than 0.5; and
δ is a number greater than 0 and not greater than 0.25.

11. The electrolyte membrane of claim 7, wherein the antioxidant is present in an amount of about 0.05 to 20% by weight, based on the weight of the electrolyte membrane.

12. A membrane-electrode assembly for vehicles comprising:
a cathode;
an electrolyte membrane disposed on the cathode and contacting the cathode; and
an anode disposed on the electrolyte membrane and contacting the electrolyte membrane,
wherein the electrolyte membrane comprises:
an ionomer; and
an antioxidant having a Perovskite structure,
wherein the antioxidant comprises barium cerium oxide and one or more rare-earth elements.

13. The membrane-electrode assembly of claim 12, wherein the ionomer is a perfluorinated sulfonic acid ionomer, a hydrocarbon ionomer and a mixture thereof.

14. The membrane-electrode assembly of claim 10, wherein the one or more rare-earth elements comprise at least one of yttrium (Y) or samarium (Sm).

15. The membrane-electrode assembly of claim 10, wherein the barium cerium oxide is doped with the one or more rare-earth elements, which is represented by the following Formula 1 or Formula 2:
BaCe₁₋ₓYₓO_{3-δ}(BCY) [Formula 1]
BaCe₁₋ₓSmₓO_{3-δ}(BCS), [Formula 2]
wherein X is a number greater than 0 and not greater than about 0.5; and
δ is a number greater than 0 and not greater than about 0.25.

16. The membrane-electrode assembly of claim 10, wherein the antioxidant is present in an amount of about 0.05 to 20% by weight, based on the total weight of the electrolyte membrane.

17. A vehicle comprising a membrane-electrode assembly of claim 10.
